(19) United States
(12) Patent Application Publication
(10) Pub. No.: US 2010/0070659 A1
(43) Pub. Date: Mar. 18, 2010

(54) METHOD AND SYSTEM FOR OPERATING AND/OR CHARGING A BATTERY POWERED USB DEVICE BASED ON A USB PORT TYPE

(76) Inventors: Kenneth Ma, Cupertino, CA (US); Chenmin Zhang, Irvine, CA (US); Alfonsus Lunardhi, San Diego, CA (US); Manisha Pandya, Anaheim Hills, CA (US); Shimon Elkayam, San Jose, CA (US)

Correspondence Address: MCANDREWS HELD & MALLOY, LTD, 500 WEST MADISON STREET, SUITE 3400, CHICAGO, IL, 60661, US

(21) Appl. No.: 12/265,503

(22) Filed: Nov. 5, 2008

Related U.S. Application Data
(60) Provisional application No. 61/097,818, filed on Sep. 17, 2008.

(51) Int. Cl. G06F 13/00; H02J 7/00

(52) U.S. Cl. 710/14; 320/137

(57) ABSTRACT

Aspects of a method and system for operating and/or charging a battery powered USB device based on a USB port type are provided. In this regard, in a USB device comprising a power management IC and a multi-function IC, a port type detection module in the multi-function IC may determine whether the USB device is attached to a standard host port or a charging port. Additionally, a power source in the power management IC, which may supply power to the port type detection module, may be enabled upon attachment of the USB device to a USB port and disabled subsequent to determination of port type. Also, one or more portions and/or functions of the power management IC may be configured based on the determined port type. Similarly, one or more portions and/or functions of the multi-function IC may be enabled or disabled based on the determined port type.

### CROSS-REFERENCE TO RELATED APPLICATIONS/INCORPORATION BY REFERENCE

This patent application makes reference to, claims priority to and claims benefit from U.S. Provisional Patent Application Ser. No. 61/097,818 filed on Sep. 17, 2008.

The above stated application is hereby incorporated herein by reference in its entirety.

### FIELD OF THE INVENTION

Certain embodiments of the invention relate to battery powered USB devices. More specifically, certain embodiments of the invention relate to a method and system for operating and/or charging a battery powered USB device based on a USB port type.

### BACKGROUND OF THE INVENTION

Universal Serial Bus (USB) is a serial bus standard utilized for interfacing electronic devices. USB enables communicatively coupling a plurality of peripheral devices to a single host. Conventionally, a USB host may comprise, for example, a laptop or desktop computer and a typical peripheral device may comprise, for example, an input device, music and/or video equipment, or a cell phone. However, USB on-the-go (OTG) enables devices to take on one of a plurality of functionalities such that devices may operate as peripherals or as hosts and thus an OTG device may be communicatively coupled to a peripheral, a host, or another OTG device.

In addition to its ability to communicate data between devices, USB may also be used to provide power to peripheral devices. Accordingly, devices may operate directly from power supplied over a USB cable or batteries may be charged via power supplied over a USB cable.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for operating and/or charging a battery powered USB device based on a USB port type, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating an exemplary USB system connection, in connection with an embodiment of the invention.

FIG. 2A is a diagram illustrating detection of a standard host port, in connection with an embodiment of the invention.

FIG. 2B is a diagram illustrating detection of a charging host port, in connection with an embodiment of the invention.

FIG. 2C is a diagram illustrating detection of a dedicated charging port, in connection with an embodiment of the invention.

FIG. 3 is a diagram illustrating an exemplary USB device comprising a power management IC and a multi-function IC, in accordance with an embodiment of the invention.

FIG. 4 is a diagram illustrating coupling USB devices via an accessory charger adapter, in accordance with an embodiment of the invention.

FIG. 5A is flow chart illustrating exemplary steps for operating and/or charging a battery powered USB device based on a detected USB port type, in accordance with an embodiment of the invention.

FIG. 5B is a flowchart illustrating exemplary steps for operating and/or charging a USB device attached to an accessory charger adapter (ACA), in accordance with an embodiment of the invention.

### DETAILED DESCRIPTION OF THE INVENTION

Certain embodiments of the invention may be found in a method and system for operating and/or charging a battery powered USB device based on a USB port type. In various embodiments of the invention, a USB device may comprise a power management IC and a multi-function IC. A port type detection module in the multi-function IC may determine whether the USB device is attached to a standard host port or a charging port. Additionally, a power source in the power management IC, which may supply power to the port type detection module, may be enabled upon attachment of the USB device to a USB port and disabled subsequent to determination of the port type. The power source may be a low dropout voltage regulator. An interface between the port type detection module and USB data lines may be set to a high impedance state subsequent determining port type. Also, one or more portions and/or functions of the power management IC may be configured based on the determined port type. Similarly, one or more portions and/or functions of the multi-function IC may be enabled or disabled based on the determined port type. A charging port may be a charging host port or a dedicated charging port and the multi-function IC may be enabled to distinguish between a charging host port and a dedicated charging port. The port type detection module may generate a charger detection signal which may indicate whether an attached port is a standard host port or a charging port. The charger detect signal may be sampled in the power management IC subsequent to an indication of attachment of the USB device to said attached port. The time at which the power management IC samples the charger detect signal may be determined via one or more of configuration by a designer of the peripheral device, configuration by a user of the peripheral device, and negotiation between the power management IC and the multi-function IC. Attachment may be indicated by a high-to-low transition of the charger detection signal. The high-to-low transition of the charger detection signal may be generated subsequent to detecting contact between one or both data lines of the USB device and one or both data lines of the attached port. In this regard, a current source may be coupled to a D+ line of the USB device for detecting contact between the D+line of the USB device and a D+ line of the attached port. Similarly, the current source may be coupled to the D− line of the USB device detecting contact between the D− line of the USB device and a D− line of the attached port.

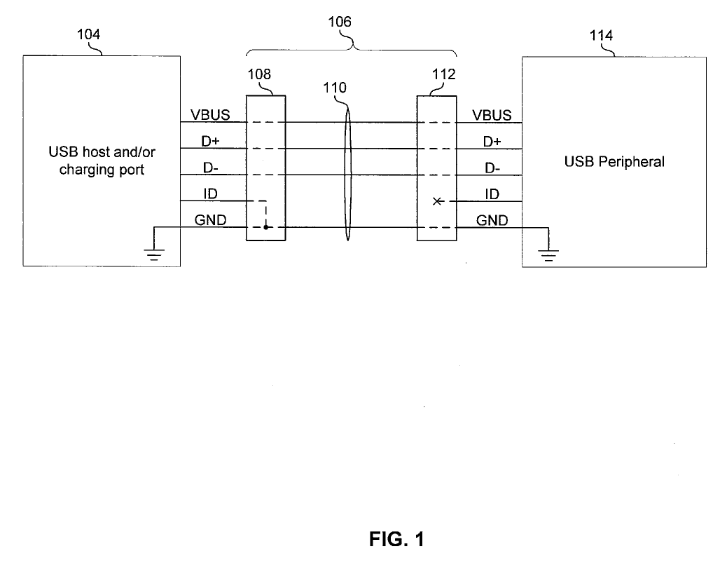

FIG. 1 is diagram illustrating an exemplary USB system connection, in connection with an embodiment of the invention. Referring to FIG. 1, a USB port 104, a USB cable 106, and a USB peripheral device 114. Although the bus 100 may be a point-to-point connection utilizing the USB on-the-go (OTG) specification and comprising a single USB port 104, a single USB cable 106, and a single peripheral device 114, the invention is not so limited. Accordingly, aspects of the invention may apply to any universal serial bus comprising any number of peripherals, links, and/or hubs. In an exemplary embodiment of the invention, the USB cable 106 may comprise an A-type plug 108, conductors 110, and B-type plug 112.

The USB port 104 may comprise suitable logic, circuitry, and/or code that may be operable to supply power on the VBUS rail. In this regard, an amount of power that the USB port 104 may deliver may depend on a type and/or configuration of the USB port 104. In instances that the USB port 104 may be a standard host port, the USB port 104 may supply up to 500 mA on the VBUS rail. In instances that the USB port 104 may be a charging host port, the USB port 104 may be operable to supply up to 1500 mA on the VBUS rail for full speed and low speed USB communications and up to 900 mA on the VBUS rail for high speed USB operations. In instances that the USB port 104 may be a dedicated charging port, the USB port 104 may be operable to supply up to 1800 mA on the VBUS rail.

The peripheral device 114 may comprise suitable logic, circuitry, and/or code operable to determine a type of port to which it may be attached and draw an amount of current from the VBUS rail based on the determination. In instances that the USB port 104 may be a standard host port, the peripheral device 114 may be configured to draw a maximum of 500 mA from the VBUS rail. In instances that the USB port 104 may be a charging host port connected at full speed or low speed, the peripheral device 114 may be configured to draw a maximum of 1500 mA from the VBUS rail. In instances that the USB port 104 may be a charging host port connected at high speed, the peripheral device 114 may be configured to draw a maximum of 560 mA from the VBUS rail during high speed chirp, and 900 mA from the VBUS rail thereafter. In instances that the USB port 104 may be a dedicated charging port, the peripheral device 114 may be configured to draw a maximum of 1800 mA from the VBUS rail.

In operation, upon being attached to the USB port 104 but prior to a USB connect event, the peripheral device 114 may initially limit the amount of current it may draw from the VBUS rail based on a current battery capacity, for example, whether a battery of the peripheral device 114 is good or weak.

Subsequently, prior to connecting to the USB port 104, the peripheral device 114 may determine whether the USB port 104 is a standard host port, a charging host port, or a dedicated charging port and may adjust current limits accordingly. If the peripheral device 114 determines that the USB port 104 is a standard host port or a charging host port, the peripheral device 114 may attempt to connect to the USB port 104 by pulling up either D− for low-speed operation or pulling-up D+ for full speed or high speed operation. In this regard, a high speed device may connect at full speed and subsequently negotiate high speed operation via a high speed chirp. Current limits may again be adjusted based on the speed at which the peripheral device 114 connects to the USB port 104. After connection, in instances that the USB port 104 is a standard host port or a charging host port, the USB port 104 may enumerate the peripheral device 114 and USB communications may begin.

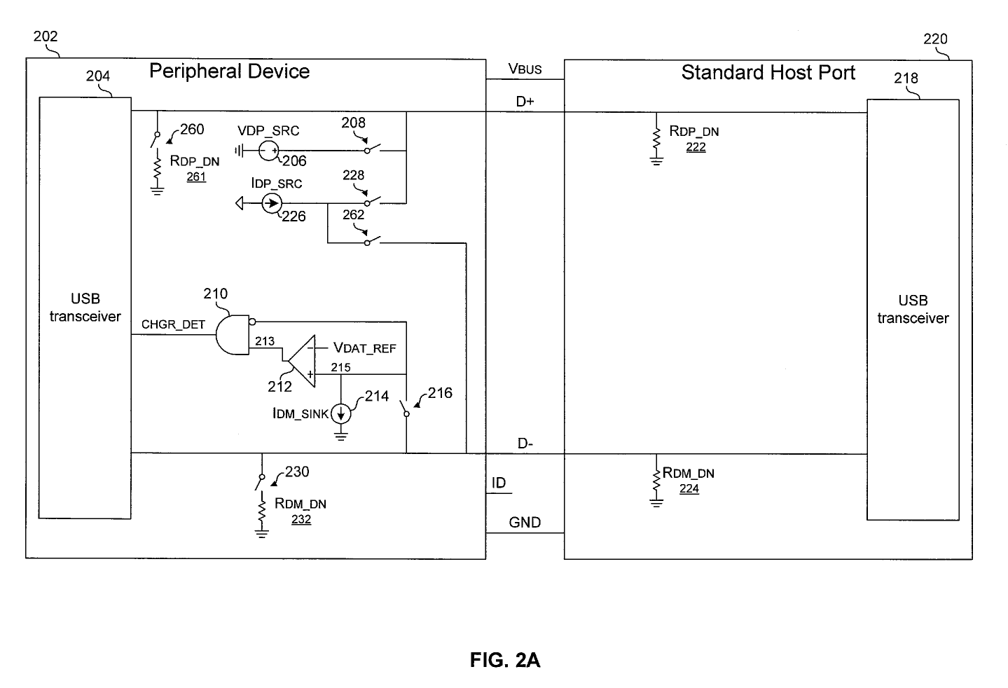

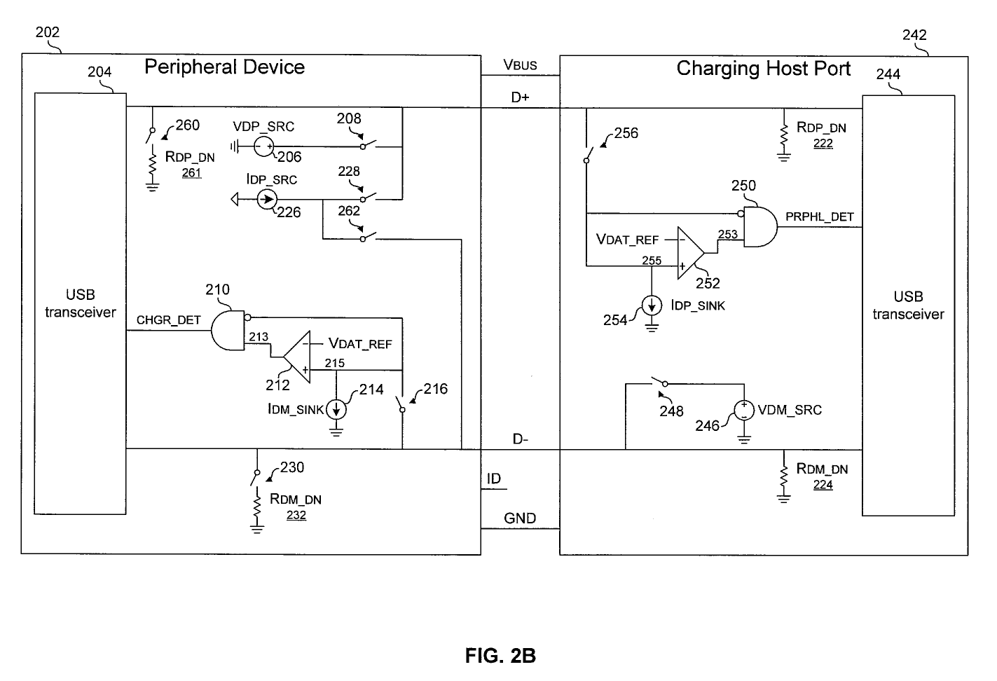

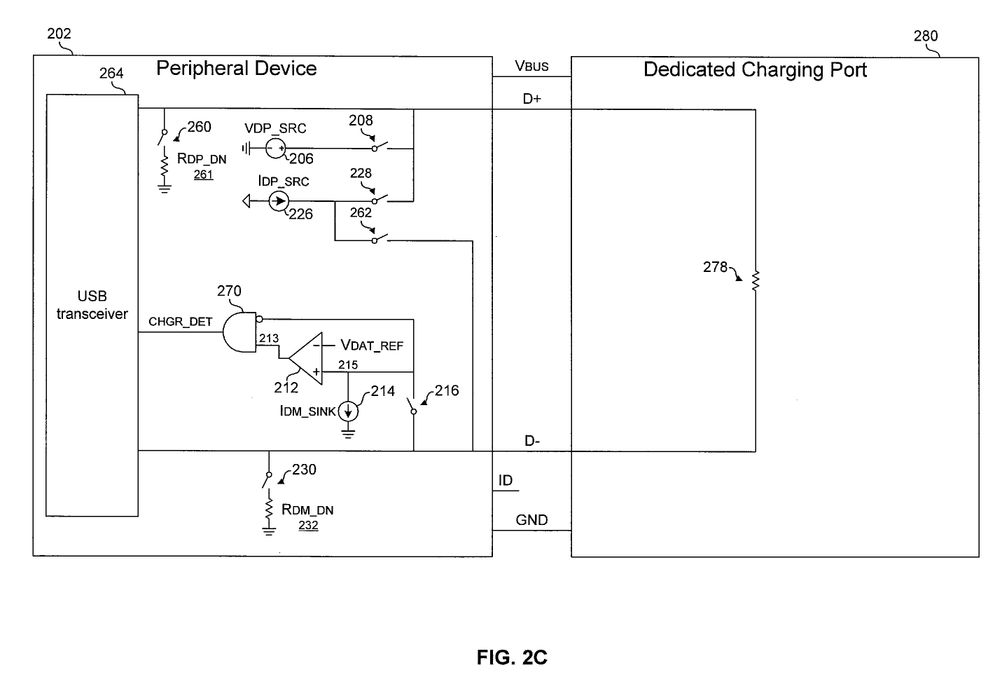

FIG. 2A is a diagram illustrating detection of a standard host port, in connection with an embodiment of the invention. Referring to FIG. 2A there is shown a peripheral device 202 attached to a standard host port 220. The peripheral device 202 may comprise a USB transceiver 204, a voltage source 206, a switching element 208, a current source 226, a switching element 228, a switching element 262, an AND gate 210, a comparator 212, a resistor RDM_DN 232, a switching element 230, a switching element 260, a resistor RDP_DN 261, a current source 214, and a switching element 216. The standard host port 220 may comprise a USB transceiver 218. The standard host port 220 may function as defined in, or be compatible with, a past, present, or future version of the USB-IF Battery Charging Specification.

The peripheral device 202 may be similar to or the same as the peripheral device 114 described with respect to FIG. 1. The standard host port 220 may be similar to the USB port 104 described with respect to FIG. 1.

The USB transceivers 204 and 218 may each comprise suitable logic, circuitry, and/or code that may be operable to transmit and receive data in adherence to USB protocols.

The voltage source 206 may comprise suitable logic, circuitry, and/or code that may be operable to generate a voltage for detecting a type of USB port to which the peripheral device 202 may be attached. In this regard, the voltage source 206 may generate a voltage, VDP_SRC, between 0.5 V and 0.7 V.

The current source 228 may comprise suitable logic, circuitry, and/or code that may be operable to supply a current to the D+ line or to the D− line to enable the peripheral device 202 to detect when the data lines D+ and D− of the peripheral device 202 have made contact, respectively, with the data lines D+ and D− of the charging host port 242.

The switching element 208 may be operable to couple and decouple the voltage source 206 from the D+ line. The switching element 208 may, for example, be opened and closed via a control signal from the USB transceiver 204.

The switching element 216 may be operable to couple and decouple the positive input of the comparator 212 to the D− line. The switching element 216 may, for example, be opened and closed via a control signal from the USB transceiver 204.

The switching element 228 may be operable to couple and decouple the current source 226 to the D+ line. The switching element 228 may, for example, be opened and closed via a control signal from the USB transceiver 204.

The switching element 262 may be operable to couple and decouple the current source 226 to the D− line. The switching element 262 may, for example, be opened and closed via a control signal from the USB transceiver 204.

The switching element 230 may be operable to couple and decouple the pull-down resistor 232 to the D− line. The switching element 230 may, for example, be opened and closed via a control signal from the USB transceiver 204.

The switching element 260 may be operable to couple and decouple the pull-down resistor 261 to the D+ line. The switching element 260 may, for example, be opened and closed via a control signal from the USB transceiver 204.

The comparator 212 may comprise suitable logic, circuitry, and/or code that may be operable to compare the node 215 to the reference voltage VDAT_REF, which may be between 0.25 V and 0.4 V. In this regard, in instances that the switching element 216 is open, node 215 may be pulled to GND by the current source 214 and the node 213 may be set to a logic low level. In instances that the switching element 216 is closed, the node 215 may be approximately equal to the voltage on the D− line and node 213 may be set to logic high level when D− is greater than VDAT_REF.

The AND gate 210 may comprise suitable logic, circuitry, and/or code that may be operable to assert CHGR_DET when the node 215 is a logic low level and the node 213 is a logic high level.

The current source 214 may comprise suitable logic, circuitry, and/or code that may be operable to sink a constant amount of current from the node 215 to GND, over a range of voltages on the node 215.

In operation, the switching elements 208 and 216 may initially be open and CHGR_DET may be a logic low level. Upon detecting attachment to the standard host port 220, based on a voltage on the VBUS rail, the peripheral device 202 may utilize data contact detection (DCD) to determine when the data lines D+ and D− of the peripheral device 202 have made contact, respectively, with the data lines D+ and D− of the standard host port 220.

Data contact detection (DCD) may be utilized because, in instances such as extremely slow insertion or a broken connection, the amount of time between VBUS contact and the data pin contact may become indeterminately long. Data contact detection for the D+ pin may be implemented as described in, or in a manner compatible with, past, current, or future versions of the USB-IF Battery Charging Specification. However, aspects of the invention may additionally enable performing data contact detection for the D− pin. In this regard, coupling the current source 226 to the D− line via the switching element 262 may enable affirmatively verifying contact of the D− pin rather than assuming the status of the D− pin is the same as the status of the D+ pin. Accordingly, upon detecting a voltage on the VBUS rail, the peripheral device may sequentially perform data contact detection for one data pin and then perform data contact detection for the other data pin. For the D+ pin, the peripheral device may close the switching elements 228 and 230 and, some time later, start sampling D+. The D+ pin may be determined to be making contact when D+ is at a low logic level. For the D− pin, the peripheral device may close the switching elements 262 and 260 and, some time later, start sampling D−. The D− pin may be determined to be making contact when D− is at a low logic level. Subsequently, switching elements 228, 230, 262, and 260 may be opened and the peripheral device 202 may attempt to determine whether it is attached to a standard host port or a charging port. In some embodiments of the invention, steps associated with DCD may by skipped and may, for example, be replaced by a delay.

Once the data pins have made contact, the peripheral device 202 may determine whether it is attached to a standard host port or a charging port. In this regard, the peripheral device 202 may close the switching element 208 to apply VDP_SRC to D+ and, some time later, close the switching element 216 to determine the voltage on D−. Since D− is pulled-down via the resistor 224 and no other voltage may be applied to D− during this time, CHGR_DET may remain at a logic low level, thus indicating that the peripheral device is attached to a standard host port. The peripheral device 202 may then open the switching elements 208 and 216 and may pull-up D− for low speed operation, or pull-up D+ for full speed or high speed operation.

FIG. 2B is a diagram illustrating detection of a charging host port, in connection with an embodiment of the invention. Referring to FIG. 2B there is shown the peripheral device 202, as described with respect to FIG. 2A, attached to a charging host port 242. The charging host port 242 may comprise a USB transceiver 244, a voltage source 246, a switching element 248, an AND gate 250, a comparator 252, a current source 254, and a switching element 256.

The charging host port 242 may be similar to the USB port 104 described with respect to FIG. 1. The USB transceiver 244 may be similar to or the same as the USB transceivers 204 and 218 described with respect to FIG. 2A. The charging host port 242 may function as defined in, or be compatible with, a past, present, or future version of the USB-IF Battery Charging Specification.

The voltage source 246 may comprise suitable logic, circuitry, and/or code that may be operable to generate a voltage, VDM_SRC, to enable a peripheral device to detect the charging host port 242. In this regard, the voltage source 246 may generate a voltage, VDM_SRC, between 0.5 V and 0.7 V.

The switching element 248 may be operable to couple and decouple the voltage source 246 from the D− line. The switching element 248 may, for example, be opened and closed via a control signal from the USB transceiver 244.

The switching element 256 may be operable to couple and decouple the positive input of the comparator 252 to the D+ line. The switching element 256 may, for example, be opened and closed via a control signal from the USB transceiver 244.

The comparator 252 may comprise suitable logic, circuitry, and/or code that may be operable to compare the node 255 to the reference voltage VDAT_REF, which may be between 0.25 V and 0.4 V. In this regard, in instances that the switching element 256 is open, the node 255 may be pulled to GND by the current source 254 and the node 253 may be set to a logic low level. In instances that the switching element 256 is closed, node 255 may be approximately equal to the voltage on the D+line and the node 253 may be set to a logic high level when D+ is greater than VDAT_REF.

The AND gate 250 may comprise suitable logic, circuitry, and/or code that may be operable to assert PRPHL_DET when node 255 is a logic high level and node 253 is a logic high level.

In operation, the switching elements 208 and 216 may initially be open and CHGR_DET may be at a logic low level. Upon detecting attachment to either a standard host port or the charging host port 242, based on a voltage on the VBUS rail, the peripheral device 202 may utilize data contact detection (DCD) to determine when the data lines D+ and D− of the peripheral device 202 have made contact, respectively, with the data lines D+ and D− of the charging host port 242. Once the data pins have made contact, the peripheral device 202 may determine whether it is attached to a standard host port or a charging port. Data contact detection may proceed as described with respect to FIG. 2A.

To determine the port type of the charging host port 242, the peripheral device 202 may close switching element 208 to apply VDP_SRC to D+. The charging host port 242 may close the switching element 256 and detect, via the comparator 252 and the AND gate 250, the voltage VDP_SRC on D+. In instances that node 255 is greater than VDAT_REF but still at a logic low level, PRPHL_DET may be set to a logic high level. In response to PRPHL_DET going to a logic high level, the charging host port 242 may close switching element 248 to apply VDM_SRC to the D− line. The peripheral device 202 may close switching element 216 to determine the voltage on D−. In this regard, VDM_SRC on D− may cause PRPHL_DET to go to a logic high level, thus indicating that the peripheral device 202 may be attached to either a charging host port or a dedicated charging port. The peripheral device 202 may then open the switching elements 208 and 216 and the charging host port may open the switching elements 248 and 256. Subsequently, the peripheral device 202 may pull-up D− for low speed operation or pull-up D+ for full speed or high speed operation. For low speed operation, subsequent to pulling up D−, D+ may remain at a logic low level, thus indicating that the peripheral device 202 is attached to a charging host port. For full speed or high speed operation, subsequent to pulling up D+, D− may remain at logic low level, thus indicating that the peripheral device 202 is attached to a charging host port.

FIG. 2C is a diagram illustrating detection of a dedicated host port, in connection with an embodiment of the invention. Referring to FIG. 2C there is shown the peripheral device 202, as described with respect to FIG. 2A, attached to a dedicated charging port 280. The dedicated charging port 280 may comprise a resistor 278. The resistor 278 may have a minimum resistance of 0 ohms and maximum of 200 ohms and thus may essentially act as an electrical short between D+ and D−. The dedicated charging port 280 may function as defined in, or be compatible with, a past, present, or future version of the USB-IF Battery Charging Specification.

In operation, the switching elements 208 and 216 may initially be open and CHGR_DET may be a logic low level. Upon detecting attachment to either a standard host or the charging port 280, based on a voltage on the VBUS rail, the peripheral device 202 may utilize data contact detection (DCD) to determine when the data lines D+ and D− of the peripheral device 202 have made contact, respectively, with the data lines D+ and D− of the USB port 280. Once the data pins have made contact, the peripheral device 202 may determine whether it is attached to a standard host port or a charging port. Data contact detection may proceed as described with respect to FIG. 2A.

To determine the port type of the port 280, the peripheral device 202 may close the switch element 208 to apply VDP_SRC to D+ and close the switching element 216 to determine the voltage on D−. In this regard, due to the short between D+ and D−, the voltage on D− may be approximately VDP_SRC and thus CHGR_DET may go to a logic high level indicating that the peripheral device 202 may be attached to either a charging host port or a dedicated charging port. The peripheral device 202 may then open switching element 208 and 216 and subsequently pull-up D− for low speed operation or pull-up D+ for full speed or high speed operation. For low speed operation, due to the electrical short between D+ and D−, pulling up D− may also pull-up D+ which may indicate that the peripheral device 202 is attached to a dedicated charging port. For full speed or high speed operation, due to the electrical short between D+ and D−, pulling up D+ may also pull-up D− which may indicate that the peripheral device 202 is attached to a dedicated charging port.

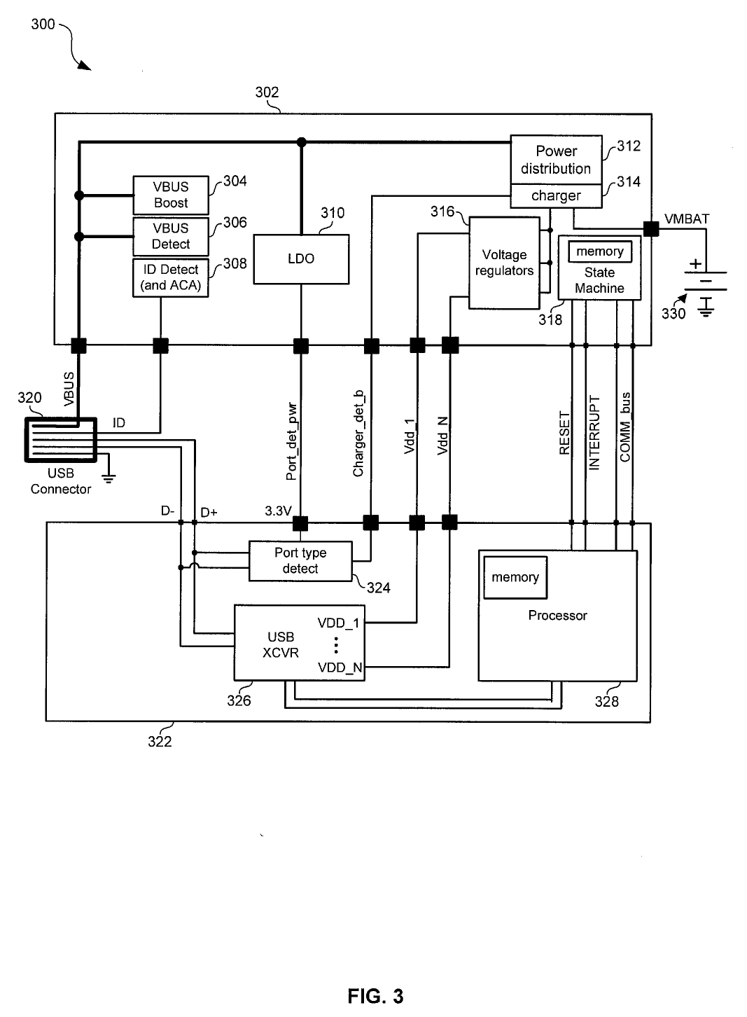

FIG. 3 is diagram illustrating an exemplary USB device comprising a power management IC and a multi-function IC, in accordance with an embodiment of the invention. Referring to FIG. 3 the USB device 300 may comprise a power management IC (PMIC) 302, a USB connector 320, a battery 330, and a multi-function IC (MFIC) 322. The USB device 300 may be similar to or the same as the peripheral device 202 described with respect to FIGS. 2A-2C; however, the USB device 300 may function as a USB host in some instances.

The USB connector 320 may, for example, comprise a standard-A, standard-B, mini-A, mini-B, mini-AB, micro-A, micro-B, micro-AB, or power B connector, however, the invention is not limited with regard to the physical connector or USB specification. Accordingly, aspects of the invention may apply to any past, current, or future generations of connectors and/or USB specifications. Although a conventional USB device may always operate as a host or as a peripheral, USB OTG enables a device to operate as a host in some instances and as a peripheral in other instances. In this regard, USB OTG provides for A-type and B-type devices with the distinction being that an A-type device supplies VBUS and a B-type device receive VBUS. Whether the USB device 300 functions as an A-type device or B-type device may be determine based on the resistance between the ID pin to ground or the voltage on the ID pin. By default, an A-type device may function as a host by default and a B-type device may function as a peripheral; however, this may be changed via the host negotiation protocol (HNP).

The battery 330 may comprise suitable logic circuitry, and/or code that may be operable to supply power to the PMIC 302. Additionally, the battery 330 may be charged via power received from the VBUS rail in accordance with past, present, and/or future versions of the USB-IF Battery Charging Specification.

The PMIC 302 may comprise suitable logic, circuitry, and/or code for receiving, generating, conditioning, distributing, or otherwise processing supply voltages and currents in the USB device 300. In this regard, the PMIC 302 may control power consumption in the USB device 300. Accordingly, in some embodiments of the invention, the PMIC 302 may control which functions and/or portions of the USB device 300 may be enabled or disabled. The PMIC 302 may comprise a VBUS boost module 304, a VBUS detect module 306, an ID detect module 308, a low dropout voltage regulator (LDO) 310, a power distribution module 312, a charger module 314, one or more voltage regulators 316, and a state machine 318. In various embodiments of the invention, the PMIC 302 may be an IC with relatively large feature size due to the presence of relatively high voltages. In this regard, the PMIC 302 may control power consumption in the device 300.

The VBUS boost module 304 may comprise suitable logic, circuitry, and/or code that may be operable to drive the VBUS rail. In this regard, in instances that the USB device 300 may not be attached to a USB host or charging port, the VBUS boost module 304 may supply power to the VBUS rail. In this regard, if the USB device is operating as an A-type (host) device, then the VBUS boost module 304 may supply VBUS to an attached B-type device. In various embodiments of the invention, the VBUS boost module 304 may be either integrated inside the PMU 302 or as a module physically separate from the PMIC 302. Additionally, control signals to the VBUS boost may be provided from the PMU 404 and/or from the MFIC 406.

The VBUS detect module 306 may comprise suitable logic, circuitry, and/or code that may be operable to detect when a voltage is applied to the VBUS rail from the connector 320. In various embodiments of the invention, the VBUS detect module 306 may indicate when the VBUS rail is above a minimum voltage.

The ID detect module 308 may comprise suitable logic, circuitry, and/or code that may be operable to determine the state of the ID pin of the connector 320. In this regard, for USG OTG, ID being coupled to GND may cause the USB device 300 to operate as an A-type device and function as a host, whereas the ID pin floating at logic high level may direct the USB device 300 to operate as a B-type device and function as a peripheral. In some embodiments of the invention, the ID detect module 308 may support attachment to an accessory charger adapter (ACA) as described in the USB-IF Battery Charging Specification. In this regard, the ID detect module 308 may be enabled to compare the voltage on the ID pin to an increased number of thresholds, rather than just determining whether the ID pin is “logic high” and “logic low”.

The low dropout voltage regulator (LDO) 310 may comprise suitable logic, circuitry, and/or code that may be operable to generate a supply voltage for the port type detection module 324. In this regard, the LDO 310 may output a voltage on port_det_pwr subsequent to a detection of a valid voltage on VBUS and prior to the port type detection module 324 determining a type of port to which the USB device 300 may be attached. Accordingly, the LDO 310 may generate port_det_pwr from the VBUS rail conditioned upon one or more enable signals (not shown). In various exemplary embodiments of the invention, the one or more enable signals input to the LDO 310 may be generated by the state machine 318.

The power distribution module 312 may comprise suitable logic, circuitry, and/or code that may be operable to control the distribution of power throughout the USB device 300. In this regard, the power distribution module 312 may determine how much current may be allocated for charging the battery 330 and/or for operation of the USB device 300. Accordingly, the power distribution module 312 may enable and/or disable various portions and/or functions within the PMIC 302 and/or the MFIC 322. In instances that the battery 330 may be dead and/or there may not be sufficient current available from the VBUS rail to power up the USB device 300, the power distribution module 312 may allocate all current from VBUS to charging the battery 330. In instances that there may be some charge in the battery and there may not be sufficient current from the VBUS rail to power up and/or operate the USB device 300, then the power distribution module 312 may allocate current from both the VBUS rail and the battery 330 to one or more of the regulators 316. In such instances, an amount of current drawn from the battery may be equal to the difference between the available current from the VBUS rail and the necessary current for power up and/or operation of the USB device 300. In instances that the USB device 300 may power up and operate from the VBUS rail alone, then the power distribution module 312 may allocate VBUS rail current to one or more of the regulators 316 and may allocate any remaining current to charging the battery 330.

The charger module 314 may comprise suitable logic, circuitry, and/or code that may be operable to enable charging of the battery 330. In this regard, the charger 314 may be operable to provide appropriate charging voltages and/or currents to the battery 330. Charging of the battery 330 may be based on one or more control signals (not shown) from the state machine 318 and/or the power distribution module 312. In various embodiments of the invention, the charger module 314 may generate one or more signals indicating the charge status of the battery 330.

The voltage regulator(s) 316 may each comprise suitable logic, circuitry, and/or code that may be operable to regulate and/or condition the VBUS rail to generate one or more voltages for powering portions of the MFIC 322 other than the port type detection module 324. In various embodiments of the invention, the voltage regulator(s) 316 may be one or more linear and/or switching regulators. In an exemplary embodiment of the invention, the voltage regulator(s) 316 may generate ‘N’ voltages where ‘N’ may be an integer greater than or equal to 1.

The state machine 318 may comprise suitable logic, circuitry, and/or code that may be operable to control, at least in part, operations of the PMIC 302 and the MFIC 322. The state machine 318 may output interrupts and reset signals to the processor 328. The state machine 318 may exchange information with the processor 328 via an inter-chip communication bus. Exemplary communication busses may comprise inter-integrated circuit communication (I²C), serial peripheral interface (SPI), and system power management interface (SPMI) of mobile industry processor interface (MIPI) organization. The state machine 318 may output one or more control signals to, and/or receive one or more signals from, the charger module 314, the power distribution module 312, the LDO 310, the ID detect module 308, the VBUS detect module 306, and/or the VBUS boost module 304.

The MFIC 322 may comprise suitable logic, circuitry, and/or code for communicating per USB standards. Additionally, the MFIC 322 may be a system on chip (SOC) and may comprise suitable logic, circuitry, and/or code which may enable, for example, mobile phone functionality, mass storage device functionality, input device functionality, and/or media player functionality. In various exemplary embodiments of the invention, the MFIC 322 may comprise, at least, a port type detection module 324, a USB transceiver 326 and a processor 328.

The port type detection module 324 may comprise suitable logic, circuitry, and/or code operable to determine a type of USB port to which the USB device 300 may be connected. In this regard, the port type detection module 324 may be operable to determine whether a USB port is a standard host port, or a charging port. In this regard, a charging port may be a charging host port or a dedicated charging port.

The USB transceiver 326 may comprise suitable logic, circuitry, and/or code that may be operable to communicate in adherence with USB standards. Accordingly, the USB transceiver 326 may be operable to exchange data with the processor 328, packetize and/or arrange data in accordance with USB standards, and generate USB physical layer signals for communicating data over a USB link. In some embodiments of the invention, the USB transceiver 326 may be operable to perform and/or support host negotiation protocol (HNP) and session request protocol (SRP).

The processor 328 may comprise suitable logic, circuitry, and/or code that may be enabled to control operations of the MFIC 322. The processor 328 may control operation of one or more portions of the MFIC 322 based on the interrupt and reset signals received from the PMIC 302. The MFIC 322 may exchange information with the PMIC 302 via the COMM_BUS. The COMM_BUS may, for example, be an I2C bus, a SPI bus, a MIPI bus, or a SPMI bus. The processor 328 may execute one or more instructions for performing functions related to USB communications. In this regard, the processor 328 may control one or more switching elements within the USB transceiver 326 for determining if a charging port is a charging host port or a dedicated charging port. Additionally, the processor 328 may execute one or more instructions which may enable, for example, mobile phone functionality, mass storage device functionality, input device functionality, and/or media player functionality of the USB device 300.

In various embodiments of the invention, the PMIC 302 may comprise analog circuitry and/or may need to handle relatively high voltages. Accordingly, the PMIC 302 may require circuit components, such as transistors, resistors, capacitors, of relatively large feature sizes. Thus, it may be more cost efficient to realize the PMIC on a larger feature size process since components of the PMIC may not be scalable with feature size. Conversely, the MFIC 322 may comprise primarily digital circuitry and thus may only need to handle relatively low voltages. Accordingly, the MFIC 322 may be realized utilizing circuit components, such as transistors, resistors, capacitors, of relatively small feature sizes. Thus, it may be cost efficient to realize the MFIC on a smaller feature size process since the components of the MFIC may scale with feature size. For example, the PMIC may be realized in a 0.18 μm, 0.25 μm, or 0.35 μm CMOS standard or high-voltage process which may be characterized by slower switching speeds and may tolerate high(er) voltages, whereas the MFIC may be realized in a 65 nm or 45 nm CMOS process which may be characterized by faster switching speeds but may not tolerate high(er) voltages.

In operation, upon attaching the connector 320 to a USB port, the LDO 310 and the port type detection module 324 may power up. The port type detection module 324 may determine whether the attached USB port may be a charging port (either a charging host port or a dedicated charging port) or a standard host port. The result of the determination may be conveyed to the PMIC 302 where it may be stored in a register. Subsequently, the LDO 310 and the port type detection module 324 may be powered down and/or disabled until the connector 320 is detached from the USB port and subsequently reattached to a USB port or alternatively, until the voltage on the VBUS rail is de-asserted and then re-asserted.

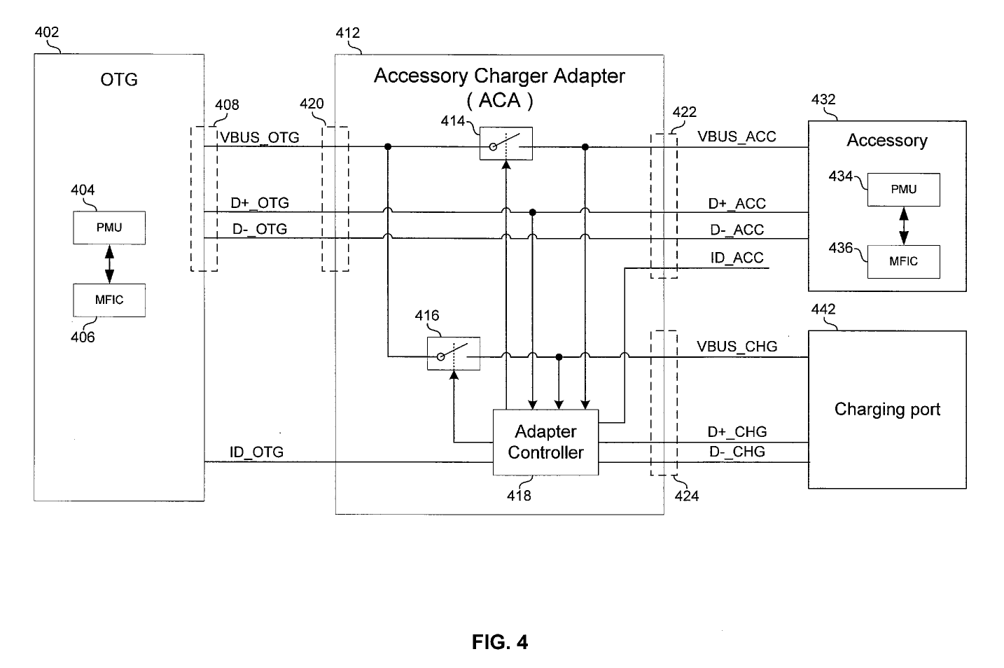

FIG. 4 is a diagram illustrating coupling USB devices via an accessory charger adapter, in accordance with an embodiment of the invention. Referring to FIG. 4 there is shown USB device 402 (“OTG device”), ACA 412, USB device 432 (“accessory”), and charging port 442.

The OTG device 402 may be a USB OTG (USB On-The-Go) device operable to function as a host or a peripheral; compatible with USB OTG specifications established by the USB-IF. The OTG device 402 may be similar to or the same as the USB device 300 described with respect to FIG. 3. The OTG device 402 may comprise a PMIC 404 and a MFIC 406 which may be similar to or the same as the PMIC 302 and a MFIC 322, respectively, described with respect to FIG. 3. The PMIC 404 may be operable to perform enhanced ID detection by distinguishing between more than two voltage levels on the ID pin. In this regard, the ID and corresponding threshold may be as defined below in Table 1.

TABLE 1
ID Detection with ACA Support

| Threshold | |
|---|---|
| (R = resistance between ID pin and GND) | ID |
| R < 10 Ω | “Ground” |
| * R > 100 kΩ | “Float Legacy” |
| * R > 1000 kΩ | “Float” |
| 102 kΩ < R < 114 kΩ | “RID_A_CHG” |
| 171 kΩ < R < 189 kΩ | “RID_B_CHG” |
| 256 kΩ < R < 284 kΩ | “RID_C_CHG” |
| Voltage on ID pin ≧ VBUS | “factory” or “test” |

“Float Legacy” may provide compatibility with older USB devices. The PMIC 404 may have a control bit which may select “Float” or “Float Legacy.” Additionally, the PMIC 404 may be enabled to tolerate and remain functional in the event of such as contention on the VBUS rail. To explain, the charger may be attached while the USB device is already providing power to the accessory 432; thus there may be a time period when the charger switch and the accessory switch may both be in the closed position.

The accessory 432 may be an accessory operable to function as a USB peripheral. The accessory 432 may be similar to or the same as the USB device 300 described with respect to FIG. 3. The accessory 432 may comprise a PMIC 404 and a MFIC 406 which may be similar to or the same as the PMIC 302 and a MFIC 322, respectively, described with respect to FIG. 3.

The charging port 442 may be a dedicated charging port similar to or the same as the dedicated charging port 280 described with respect to FIG. 2C or a charging host port 242 described with respect to FIG. 2B.

The ACA 412 may enable the simultaneous attachment of the accessory 432 and the charging port 442 to the OTG device 402 even though the OTG device 402 may only comprise a single USB port 408. The ACA 412 may comprise an accessory switch 414, a charger switch 416, a controller 418, an OTG port 420, an accessory port 422, and a charger port 424. The accessory switch, when in the closed position, may couple the VBUS rail of the OTG device 402 and the VBUS rail of the accessory 432. The charger switch, when in the closed position, may couple the VBUS rail of the OTG device 402 and the VBUS rail of the charging port 442. the controller 418 may comprise suitable logic, circuitry, and/or code that may enable determining the state of the ID pin of the accessory 432, outputting a state onto the ID pin of the OTG device 402, detect whether a charger is attached to the charger port 424, sense the voltage on the VBUS rail of the accessory 432, and control the accessory switch 414 and the charger switch 416.

In operation, the PMIC 404, the MFIC 406, the PMIC 434, and the MFIC 436 may enable charging of the OTG device 402 and/or the accessory 402 and/or USB communications between the OTG device 402 and the accessory 432. In various embodiments of the invention, the PMIC 404 may manage power consumed by the OTG device 402 and provided to the accessory 432 so as to balance tradeoffs required due to finite power availability, In this regard, the PMIC 404 may determine how much, if any, current to allocate for power up of the OTG device 402, power up of the accessory 432, charging of a battery of the OTG device 402, and charging of a battery of the accessory 432. This allocation of power may be determined based on, for example, an amount of current available from the charging port 442, a state of a battery of the OTG device 402, current required for operation of the accessory 432, the voltage level on VBUS, and a state of a battery of the accessory 432.

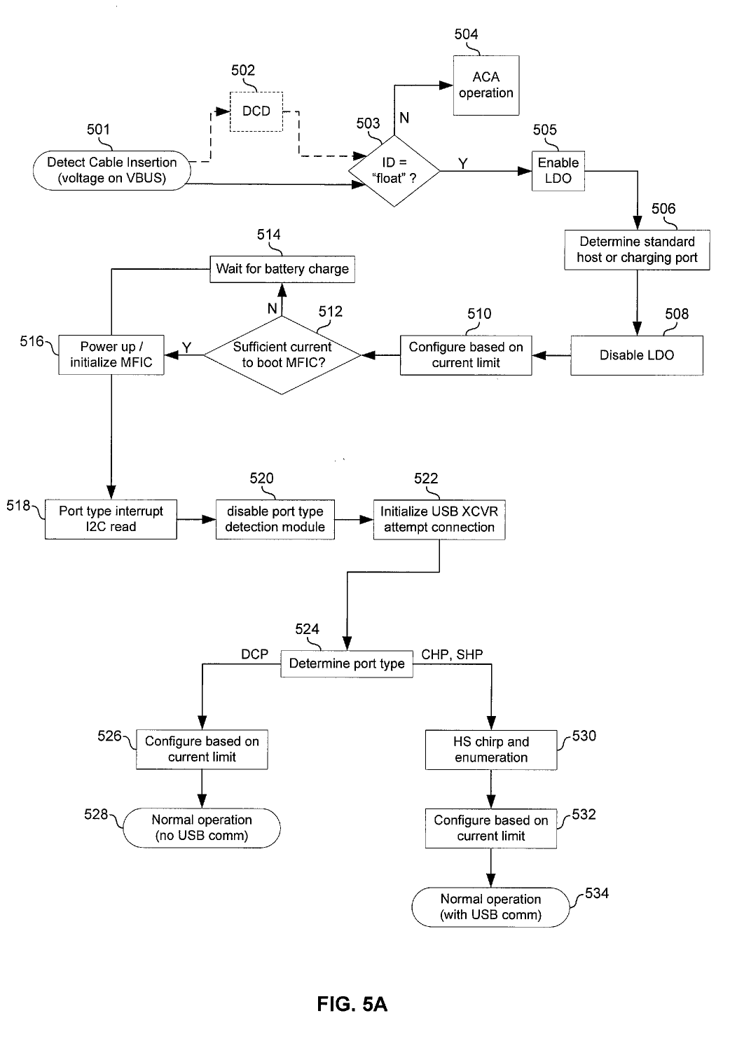

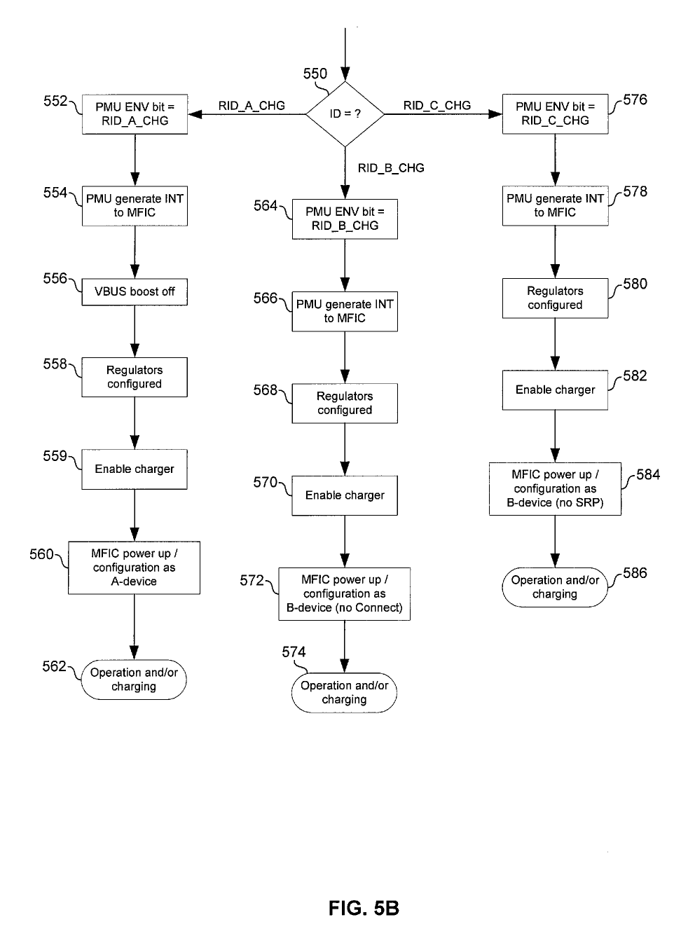

FIG. 5A is flow chart illustrating exemplary steps for operating and/or charging a battery powered USB device based on a detected USB port type, in accordance with an embodiment of the invention. The exemplary steps are described with regards to the peripheral device described with respect to FIG. 3. Referring to FIG. 5A, the exemplary steps may begin with step 502.

In step 501, the connector 320 may be attached to a USB port. Upon attachment of the connector 320 to a USB port, the VBUS detection module 306 may detect the voltage on the VBUS rail and indicate the attachment to the state machine 318. Prior to determining the port type of the attached port and/or prior to establishing a valid USB connection between the USB device 300 and the attached port, the PMIC 302 and the MFIC 322 may be configured such that current drawn from VBUS may be limited. The current may be limited to 2.5 mA when the charge of the battery 330 may be above a threshold and 100 mA when the charge of the battery 330 may be below a threshold. Subsequent to step 501, the exemplary steps may advance to step 503, or in some instances may advance to step 502 for data contact detection.

In step 502, data contact detection may be implemented. In this regard, the port type detection module 324 may detect when the data pins D+ and D− have made contact. In various embodiments of the invention, the port type detection module 324 may perform pin contact detection for each of the D+ and D− pins. For example, in the peripheral device 202 of FIGS. 2A-2C, the port type detection module 324 may first perform contact detection for the D+ pin by turning on switches 228 and 230 while monitoring the voltage level on D+; D+ pin contact detection may be complete when D+ is at logic low. The port type detection module 324 may then perform data contact detection for the D− pin by turning on switches 262 and 260 while monitoring the voltage level on D−; D− pin contact detection may be complete when D− is at logic low. Subsequent to detecting contact of the D+ and D− pins, the port type detection module 324 may generate a high-to-low transition (falling edge) on Charger_det_b. The high-to-low transition of Charger_det_b may inform the PMIC 302 that data contact detection is complete. After data contact, the PMIC 302 may wait for a determined delay before sampling Charger_det_b and attempting to determine the type of port to which the USB device 300 is attached. Subsequent to step 502, the exemplary steps may advance to step 503.

In step 503, the ID detect module may determine the voltage of the ID pin. In instances that the ID pin may be “RID_A_CHG”, “RID_B_CHG”, or “RID_C_CHG”, the exemplary steps may advance to step 504. In instances that the ID pin may be “float” the exemplary steps may advance to step 505.

In step 504, the USB device may be attached to an accessory charger adapter and operation of the USB device may be as described with respect to the flowchart of FIG. 5B.

In step 505, the state machine 318 may generate one or more signals to enable the LDO 310 which in turn may generate a supply voltage Port_det_pwr from the VBUS rail. In this regard, Port_det_pwr may be a voltage rail which may supply power to the port type detection module 324. Accordingly, once Port_det_pwr is up and stable, the port type detection module 324 may undergo a power-on reset (POR) and may initialize to a default configuration for which Charger_det_b may be asserted. In this regard, the default configuration of the PMIC 302 and/or the MFIC 322 may correspond to the connector 320 being attached to a standard port. This may prevent the USB device 300 from attempting to draw too much current from a standard port. Subsequent to step 505, the exemplary steps may advance to step 506.

In step 506, the port type detection module 324 may determine whether the port attached to the connector 320 may be a standard host port or a charging port. The determination may be performed by applying a voltage to the data line D+ and, after some delay, determining a resulting voltage on D−. In instances that a standard host port may be detected, Charger_det_b may remain asserted. In instances that a charging host port may be detected, the port type detection module 324 may deassert Charger_det_b. After waiting a sufficient amount of time for the port type detection module 324 to initialize and generate Charger_det_b, the value of Charger_det_b may be stored in a register. The amount of time which the PMIC 302 waits between insertion detection in step 502 and sampling and/or storing Charger_detect_b in step 506 may be configured by a system designer, configured by a user of the USB device 300, and/or negotiated between the PMIC 302 and the MFIC 322. In this regard, the delay may prevent the PMIC 302 from prematurely sampling Charger detect_b before various components of the peripheral device have initialized and/or before signal levels have settled. The stored value of Charger_det_b may be utilized for operation of the state machine 318 and/or may be read by the processor 328 via the inter-chip communication bus. Subsequent to step 506, the exemplary steps may advance to step 508.

In step 508, the state machine 318 may generate one or more signals to disable the LDO 310. In this manner, power consumption in the USB device 300 may be reduced since the LDO 310 may not be needed until after the connector 320 may be detached from and subsequently reattached to a USB port. Subsequent to step 508, the exemplary steps may advance to step 510.

In step 510, a limit on how much current may be drawn from the VBUS rail may be adjusted. For a standard host port the current limit may be maintained at the limit established in step 502. For a charging port (either a charging host port or a dedicated charging port) the current limit may be increased. Accordingly, for a charging port, one or more portions of the power distribution module 312, the charger module 314, and/or the voltage regulator(s) 316 may be enabled and/or configured based on the new current limit. In some instances, to prevent exceeding the VBUS current limit, at least a portion of one or more of the power distribution module 312, the charger module 314, and/or the voltage regulator(s) 316 may remain disabled until the battery 330 is charged above a threshold. Subsequent to step 510, the exemplary steps may advance to step 512.

In step 512, it may be determined whether there may be sufficient current available from VBUS and/or the battery 330 to power at least minimum required functions and/or portions of the MFIC 322. In instances that sufficient current is not available, the exemplary steps may advance to step 514.

In step 514, VBUS current may be used solely to charge the battery 330 and the voltage regulator(s) 316 may remain powered off. Once sufficient current is available from VBUS and/or the battery 330 to power at least the minimum required functions and/or portions of the MFIC 322, the exemplary steps may advance to step 516.

Returning to step 512, in instances that sufficient current is available from VBUS and/or the battery 330 to power at least the minimum required functions and/or portions of the MFIC 322, the exemplary steps may advance to step 516.

In step 516, one or more portions of the voltage regulator(s) 316 may be enabled and at least the minimum required functions and/or portions of the MFIC 322 may be powered up. In an exemplary embodiment of the invention, the minimum required functions and/or portions of the MFIC 322 may comprise at least a portion of the processor 328, the inter-chip communication bus, and the USB transceiver 326. Whether or not the enabled portion of the voltage regulator(s) 316 may support more than minimum required portions and/or functions of the MFIC 322 may be determined based on the status of the battery 330, the value of Charger_det_b, and/or one or more control registers. Subsequent to step 516, the exemplary steps may advance to step 518.

In step 518, a “port type” interrupt may be generated by the state machine 318. The “port type” interrupt may cause the processor 328 to read the value of Charger_det_b from the PMIC 302 via the inter-chip communication bus. The value of Charger_det_b may be utilized by the MFIC 322 to determine which portions and/or functions of the MFIC 322 may be enabled. For example, only the minimum required portions and/or functions of the MFIC 322 may be enabled for a standard port whereas more than the minimum portions and/or functions of the MFIC 322 may be enabled for a charging port. Subsequent to step 518, the exemplary steps may advance to step 520.

In step 520, the processor 328 may generate one or more control signals to disable the port type detection module 324. In this manner, power consumption in the USB device 300 may be reduced since the port type detection module 324 may not be needed until after the connector 320 may be detached from and subsequently reattached to a USB port. When the port type detection module is disabled, its interfaces to the data lines D+ and D− may be set to a high impedance state. The high impedance state may prevent or limit the impact of loading from the port type detection module 324 on the data lines. Subsequent to step 520, the exemplary steps may advance to step 522.

In step 522, the processor 328 may enable and/or initialize the USB transceiver 326 and attempt to establish a connection between the USB transceiver 326 and the attached port. Depending on the desired connection speed, the processor 328 may provide one or more control signals to the USB transceiver 326 to pull-up the data line D+ or the data line D−. In this regard, while attempting to connect to the attached port, it may also be determined whether the attached port may be a dedicated charging port by pulling-up one of the data lines and checking the resulting logic level on the other data line. For example, in instances that D+ is pulled up and D− goes high as a result, then the attached port may be a dedicated charging port. Conversely, in instances that D+ is pulled-up and D− remains low, then the attached port may be a charging host port or a standard host port. Subsequent to step 522, the exemplary steps may advance to step 524.

In step 524, the behavior of the data lines during step 522 may be combined with the value of Charger_det_b determined in step 506 to uniquely identify the type of port attached to the connector 320, as shown below in Table 2 for low speed configurations and in Table 3 for full-speed and/or high-speed connections.

TABLE 2
Port Type Detection (Low speed)

| Charger_det_b | D+ (with D− pulled up) | Port type |
|---|---|---|
| 0 | 1 | Dedicated charging port |
| 0 | 0 | Charging host port |
| 1 | 0 | Standard host port |
| 1 | 1 | not valid |

TABLE 3
Port Type Detection (Full or high speed)

| Charger_det_b | D− (with D+ pulled up) | Port type |
|---|---|---|
| 0 | 1 | Dedicated charging port |
| 0 | 0 | Charging host port |
| 1 | 0 | Standard host port |
| 1 | 1 | not valid |

In instances that the attached port may be determined to be a dedicated charging port the exemplary steps may advance to step 526.

In step 526, a limit on how much current may be drawn from VBUS may be increased based on the determination that a dedicated charging port may be attached to the connector 320. Accordingly, one or more portions of the power distribution module 312, the charger module 314, the voltage regulator(s) 316 and/or one or more portions and/or functions of the MFIC 322 may be enabled and/or configured based on the new current limit. In some instances, to prevent exceeding the VBUS current limit, at least a portion of one or more of the power distribution module 312, the charger module 314, the voltage regulator(s) 316, and/or one or more portions and/or functions of the MFIC 322 may remain disabled until the battery 330 is charged above a threshold. Subsequent to step 526, the exemplary steps may advance to step 528.

In step 528, the USB device 300 may charge the battery 330 utilizing current from the VBUS rail and/or the USB device 300 may operate utilizing current from VBUS and/or the battery 330.

Returning to step 524, in instances that the attached port may be determined to be a dedicated charging port the exemplary steps may advance to step 530.

In step 530, enumeration and possibly high speed chirp may be performed to complete setup of the USB connection. For a charging host port, one or more inter-chip communication bus commands may be issued to the PMIC 302 to reduce the current drawn from VBUS before starting the high speed chirp. Subsequent to step 530, the exemplary steps may advance to step 532.

In step 532, a limit on how much current may be drawn from the VBUS rail may be adjusted based on the connection speed and/or the results of the enumeration. For a charging host port, the VBUS current limit may be reduced for high speed operation. For a standard host port, the VBUS current limit may be negotiated between the USB device 300 and the standard host port connected to the connector 320. Subsequent to step 532, the exemplary steps may advance to step 534.

In step 534, the USB device 300 may charge the battery 330 utilizing current from the VBUS rail and/or the USB device 300 may operate utilizing current from the VBUS rail and/or the battery 330. During operation, the USB device 300 may communicate with the port to which it is connected via the established USB connection.

FIG. 5B is a flowchart illustrating exemplary steps for operating and/or charging a USB device attached to an accessory charger adapter (ACA), in accordance with an embodiment of the invention. Referring to FIG. 5B, the exemplary steps may begin with step 550 when the PMIC 404 may determine whether a state of the ID pin corresponds to “RID_A_CHG,” “RID_B_CHG,” or “RID_C_CHG.” In instances that the state of the ID pin corresponds to “RID_A_CHG,” the exemplary steps may advance to step 552.

In step 552, one or more bits of a control register within the PMIC 404 may be set to a value indicating that the state of the ID pin to be “RID_A_CHG.” Subsequent to step 552, the exemplary steps may advance to step 554.

In step 554, the PMIC 404 may generate an interrupt which may indicate to the MFIC 406 that the state of the ID pin is “RID_A_CHG.” Subsequent to step 554, the exemplary steps may advance to step 556.

In step 556, a VBUS boost module within the PMIC 404 may be disabled to prevent a conflict on the VBUS rail, since the charging port 442 may supply the VBUS rail. Subsequent to step 556, the exemplary steps may advance to step 558.

In step 558, one or more voltage regulators within the PMIC 404 may be configured to supply power to the portions and/or functions of the MFIC 406 that may be utilized while the state of the ID pin is “RID_A_CHG.” Subsequent to step 558, the exemplary steps may advance to step 559.

In step 559, a charger module within the PMIC 502 may be enabled. In this regard, the charger module may enable utilizing current received from the charging port 442 to charge a battery of the OTG device 402. Subsequent to step 559, the exemplary steps may advance to step 560.

In step 560, the MFIC 406 may be powered up and/or initialized. In this regard, which portions and/or functions of the MFIC 406 are powered up may be determined based, at least in part, on the OTG device 502 operating as an A-type device. Subsequent to step 560, the exemplary steps may advance to step 562.

In step 562, a battery of OTG device 502 may begin charging and the OTG device 502 may begin operating as a USB host.

Returning to step 550, in instances that the state of the ID pin corresponds to “RID_B_CHG,” the exemplary steps may advance to step 564, wherein one or more bits of a control register within the PMIC 404 may be set to a value indicating that the state of the ID pin to be “RID_B_CHG.” Subsequent to step 564, the exemplary steps may advance to step 566.

In step 566, the PMIC 404 may generate an interrupt which may indicate to the MFIC 406 that the state of the ID pin is “RID_B_CHG.” Subsequent to step 566, the exemplary steps may advance to step 568.

In step 568, one or more voltage regulators within the PMIC 404 may be configured to supply power to the appropriate portions and/or functions of the MFIC 406 that may be utilized while the state of the ID pin is “RID_B_CHG.” Subsequent to step 568, the exemplary steps may advance to step 570.

In step 570, a charger module within the PMIC 502 may be enabled. In this regard, the charger module may enable utilizing current received from the charging port 442 to charge a battery of the OTG device 402. Subsequent to step 570, the exemplary steps may advance to step 572.

In step 572, the MFIC 406 may be powered up and/or initialized. In this regard, which portions and/or functions of the MFIC 406 are powered up may be determined based, at least in part, on the OTG device 502 operating as a B-type device. Subsequent to step 572, the exemplary steps may advance to step 574.

In step 574, a battery of OTG device 502 may begin charging and the OTG device 502 may begin operating as a USB peripheral. While the state of the ID pin is “RID_B_CHG,” the OTG device 502 may be enabled to perform SRP (session request protocol) data pulsing but may not be allowed to perform SRP VBUS pulsing; and may not be allowed to connect by leaving D+_OTG asserted.

Returning to step 550, in instances that the state of the ID pin corresponds to “RID_C_CHG,” the exemplary steps may advance to step 576, wherein one or more bits of a control register within the PMIC 404 may be set to a value indicating that the state of the ID pin to be “RID_C_CHG.” Subsequent to step 576, the exemplary steps may advance to step 578.

In step 578, the PMIC 404 may generate an interrupt which may indicate to the MFIC 406 that the state of the ID pin is “RID_C_CHG.” Subsequent to step 566, the exemplary steps may advance to step 580.

In step 580, one or more voltage regulators within the PMIC 404 may be configured to supply power to the appropriate portions and/or functions of the MFIC 406 that may be utilized while the state of the ID pin is “RID_C_CHG.” Subsequent to step 580, the exemplary steps may advance to step 582.

In step 582, a charger module within the PMIC 502 may be enabled. In this regard, the charger module may enable utilizing current received from the charging port 442 to charge a battery of the OTG device 402. Subsequent to step 582, the exemplary steps may advance to step 584.

In step 584, the MFIC 406 may be powered up and/or initialized. In this regard, which portions and/or functions of the MFIC 406 are powered up may be determined based, at least in part, on the OTG device 502 operating as a B-type device. Subsequent to step 584, the exemplary steps may advance to step 586.

In step 586, a battery of OTG device 502 may begin charging and the OTG device 502 may begin operating as a USB peripheral. While the state of the ID pin is “RID_C_CHG,” the OTG device 502 may be enabled to connect by asserting D+_OTG asserted but my not perform SRP (session request protocol) data pulsing or VBUS pulsing.

Aspects of a method and system for operating and/or charging a battery powered USB device based on a USB port type are provided. In an exemplary embodiment of the invention, a USB device 300 comprising a power management IC 302 and a multi-function IC 322, a port type detection module 324 in the multi-function IC 322 may determine whether the USB device 300 is attached to a standard host port (e.g., 220 of FIG. 2) or a charging port (e.g., 242 of FIG. 2B or 280 of FIG. 2C). Additionally, a power source 310 in the power management IC 302, which may supply power to the port type detection module 324, may be enabled upon attachment of the USB device 300 to a USB port and disabled subsequent to determination of port type. An interface between the port type detection module 324 and USB data lines (D− and D+) may be set to a high impedance state subsequent determining port type. Also, one or more portions and/or functions of the power management IC 302 may be configured based on the determined port type. Similarly, one or more portions and/or functions of the multi-function IC 322 may be enabled or disabled based on the determined port type. A charging port may be a charging host port 242 or a dedicated charging port 280 and the multi-function IC 322 may be enabled to distinguish between a charging host port 242 and a dedicated charging port 280. The port type detection module 324 may generate a charger detection signal, Charger_det_b, which may indicate whether an attached port is a standard host port or a charging port. The charger detect signal may be sampled in the PMIC 302 subsequent to an indication of attachment of the USB device 300 to said attached port. The time at which the PMIC 302 samples Charger_det_b may be determined via one or more of configuration by a designer of the USB device 300, configuration by a user of the USB device 300, and negotiation between the PMIC 302 and the MFIC 322. Attachment may be indicated by a high-to-low transition of Charger_det_b. The high-to-low transition of Charger_det_b may be generated subsequent to successfully detecting contact between one or both data lines of the USB device 300 and one or both data lines of the attached port. In this regard, a current source may be coupled to a D+ line of the USB device 300 for detecting contact between the D+ line of the USB device 300 and a D+ line of the attached port. Similarly, the current source may be coupled to the D− line of the USB device detecting contact between the D− line of the USB device and a D− line of the attached port.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for operating and/or charging a battery powered USB device based on a USB port type.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for bus interfacing, the method comprising:
in a USB device comprising a power management IC and a multi-function IC, determining via a port type detection module in said multi-function IC, whether said USB device is attached to a standard host port or a charging port.

2. The method according to claim 1, comprising enabling a power source in said power management IC upon attachment of said USB device to a USB port.

3. The method according to claim 2, comprise disabling said power source subsequent to said determining whether said USB device is attached to a standard host port or a charging port.

4. The method according to claim 2, wherein said power source supplies power to a port type detection module in said multi-function IC.

5. The method according to claim 1, comprising configuring an interface between said port type detection module and USB data lines to a high impedance state subsequent to said determination.

6. The method according to claim 1, comprising configuring one or more functions of said power management IC based on whether said USB device is attached to a charging port or a standard host port.

7. The method according to claim 1, comprising controlling which portions and/or functions of said multi-function IC are enabled based on whether said USB device is attached to a charging port or a standard host port.

8. The method according to claim 1, wherein said charging port may be a charging host port or a dedicated charging port.

9. The method according to claim 1, comprising determining whether said charging port is a dedicated charging port or a charging host port via said multi-function IC.

10. The method according to claim 1, comprising generating, in said port type detection module, a charger detection signal indicating whether an attached port is a standard host port or a charging port; and
sampling said charger detection signal in said power management IC at a determined time after an indication of attachment of said USB device to said attached port.

11. The method according to claim 10, wherein said time is determined via one or more of configuration by a designer of said USB device, configuration by a user of said USB device, and negotiation between said power management IC and said multi-function IC.

12. The method according to claim 10, comprising indicating said attachment of said USB device to said attached port via a high-to-low transition of said charger detection signal.

13. The method according to claim 12, wherein said high-to-low transition of said charger detection signal is generated subsequent to successfully detecting contact between one or both data lines of said USB device and one or both data lines of said attached port.

14. The method according to claim 1, comprising coupling a current source to a D+ line of said USB device and decoupling said current source from a D− line of said USB device; and
monitoring said D+ line of said USB device to detect contact between said D+ line of said USB device and a D+ line of said attached port.

15. The method according to claim 1, comprising coupling a current source to a D− line of said USB device and decoupling said current source from a D+ line of said USB device; and
monitoring said D− line of said USB device to detect contact between said D− line of said USB device and a D− line of said attached port.

16. A system for USB interfacing, the system comprising:
a USB device comprising a multi-function IC and a power management IC, wherein said multi-function IC comprises one or more circuits operable to determine whether said USB device is attached to a standard host port or a charging port.

17. The system according to claim 16, wherein said power management IC comprises a power source which may be enabled upon attachment of said USB device to a USB port.

18. The system according to claim 17, comprise disabling said power source subsequent to said determining whether said USB device is attached to a standard host port or a charging port.

19. The system according to claim 17, wherein said power source supplies power to said one or more circuits in said multi-function IC;

20. The system according to claim 16, wherein an interface between said one or more circuits and USB data lines is set to a high impedance state subsequent to a determination of whether said USB device is attached to a standard host port or a charging port.

21. The system according to claim 16, wherein one or more portions and/or functions of said power management IC are configured based on whether said USB device is attached to a charging port or a standard host port.

22. The system according to claim 16, wherein which portions and/or functions of said multi-function IC are enabled is controlled based on whether said USB device is attached to a charging port or a standard host port.

23. The system according to claim 16, wherein said charging port may be a charging host port or a dedicated charging port.

24. The system according to claim 16, wherein logic, circuitry, and/or code of said multi-function IC determines whether said charging port is a dedicated charging port or a charging host port.

25. The system according to claim 16, wherein said port type detection module generates a charger detection signal indicating whether an attached port is a standard host port or a charging port; and
said power management IC samples said charger detection signal at a determined time after an indication of attachment of said USB device to said attached port.

26. The system according to claim 25, wherein said time is determined via one or more of configuration by a designer of said USB device, configuration by a user of said USB device, and negotiation between said power management IC and said multi-function IC.

27. The system according to claim 25, wherein said attachment of said USB device to said attached port is indicated via a high-to-low transition of said charger detection signal.

28. The system according to claim 27, wherein said high-to-low transition of said charger detection signal is generated subsequent to successfully detecting contact between one or both data lines of said USB device and one or both data lines of said attached port.

29. The system according to claim 16, wherein a current source is coupled to a D+ line of said USB device and decoupled from a D− line of said USB device; and
said D+ line of said USB device is monitored to detect contact between said D+ line of said USB device and a D+ line of said attached port.

30. The system according to claim 16, wherein a current source is coupled to a D− line of said USB device and decoupled from a D+ line of said USB device; and
said D− line of said USB device is monitored to detect contact between said D− line of said USB device and a D− line of said attached port.
